(19) United States
(12) Patent Application Publication
(10) Pub. No.: US 2024/0295453 A1
(43) Pub. Date: Sep. 5, 2024

(54) DEVICE FOR LOCALLY MEASURING A NORMAL MECHANICAL STRESS EXERTED BY A CONTACT ELEMENT

(71) Applicants: PARIS SCIENCES ET LETTRES, PARIS (FR); CENTRE NATIONAL DE LA RECHERCHE SCIENTIFIQUE, PARIS (FR); ECOLE SUPERIEURE DE PHYSIQUE ET DE CHIMIE INDUSTRIELLES DE LA VILLE DE PARIS, PARIS (FR)

(72) Inventors: Mickaël PRUVOST, PARIS (FR); Anaïs GAUTHIER, PARIS (FR); Annie COLIN, BEGLES (FR)

(21) Appl. No.: 18/258,322

(22) PCT Filed: Dec. 17, 2021
(86) PCT No.: PCT/FR2021/052378

§ 371 Date: Jun. 19, 2023

(30) Foreign Application Priority Data
Dec. 22, 2020 (FR) 2013888

(51) Int. Cl. G01L 9/00

(52) U.S. Cl. CPC G01L 9/0072

(57) ABSTRACT

The present invention relates to a device for locally measuring a normal mechanical stress exerted by a contact element, said device comprising:—a substrate comprising, over at least a part of its surface, at least one electrically conductive layer, called the lower electrode,—a first electrically insulating polymeric layer having a thickness of between 1 μm and 500 μm and comprising at least one through-cavity, the first polymeric layer being arranged on the substrate,—a structure arranged on the first polymeric layer, the structure comprising the following successive layers.

The present invention relates to the field of measuring a normal mechanical stress exerted by a contact element. More particularly, the invention relates to a device for locally measuring a normal mechanical stress exerted by a contact element and a method for manufacturing such a device.

In the current state of the art, silicon-based devices in particular are known, which are suitable for creating rheometer planes and including capacitive sensors and which make it possible to measure a normal mechanical stress exerted by a contact element, for example a pressure applied by a fluid.

However, in the current state of the art, the use of known devices is not simple insofar as it requires the implementation of numerous steps that are not optimized economically or temporally. Furthermore, the rheometer planes of each of the currently known devices are not suitable for all rheometers but only for a single particular type of rheometer.

It should be noted that with conventional and currently used rheometers, it is necessary to perform two measurements in order to obtain a normal stress difference in order to obtain a local rheological measurement of the pressure of a fluid under shear conditions for example. However, the fact of having to perform these two measurements results in a significant risk of error^{[1]} due to the measurement error committed in each of these two measurements.

Furthermore, in order to measure a pressure applied to different zones of the same surface upon which a fluid exerts pressure, a measurement is currently carried out on each of these zones by repositioning the conventional rheometer.

However, in the current state of the art, there is no device that is easy to use, that is to say, for which the placement thereof is not related to the implementation of several lengthy steps, and optimized to measure locally, and accurately, a normal mechanical stress exerted by a contact element insofar as the currently known devices do not comprise:
detection surfaces that are sufficiently small relative to the surface of the rheometer to obtain local measurements,
sensors that are sufficiently sensitive to measure stresses in the magnitude of 10 Pa, and
sensors suitable for not disturbing the contact element, for example during the local flow of the fluid, the pressure thereof is to be measured.

One of the aims of the invention is to remedy the shortcomings of devices for measuring normal mechanical stresses of the prior art.

According to a first aspect, the invention relates to a device for locally measuring a normal mechanical stress exerted by a contact element, said device comprising:
a substrate comprising, over at least a part of its surface, at least one electrically conductive layer, called the lower electrode,
a first electrically insulating polymeric layer having a thickness of between 1 μm and 500 μm and comprising at least one through-cavity, the first polymeric layer being arranged on the substrate,
a structure arranged on the first polymeric layer, the structure comprising the following successive layers:
   a dielectric layer having a thickness of between 50 μm and 2000 μm and being arranged on the first polymeric layer,
   an electrically conductive monolithic layer, referred to as the upper electrode, the monolithic layer having a thickness of between 5 μm and 50 μm, and
   a second polymeric layer comprising a surface intended to be in contact with the contact element, the second polymeric layer having a thickness of between 10 and 500 μm, the through-cavity being defined by a volume and extending between the electrically conductive layer and the dielectric layer,
the assembly comprising the through-cavity, the dielectric layer and the lower and upper electrodes forming a capacitor,
the structure being elastically deformable so that when a normal mechanical stress is exerted on the surface of the second polymeric layer intended to be in contact with the contact element, the volume of the through-cavity varies so as to modify the capacitance of the capacitor.

The first polymer layer makes it possible to separate the lower electrode from the upper electrode and to isolate the surface intended to be in contact with the contact element of the lower electrode.

In the context of the present invention, the term “contact element” means any type of liquid, gas, paste, solid or semi-solid capable of exerting a normal stress on the surface of an object. For example, the skin of a living being can be cited.

For the purposes of the present invention, the term “elastically deformable structure” means a three-dimensional structure that is deformable elastically in compression. Preferably, the Young's modulus in compression of the structure is between 0.5 MPa and 5 MPa. Using a structure with such a Young's modulus makes it possible to guarantee that the capacitor is operational over a wide sensitivity range insofar as the structure is too soft with a Young's modulus in compression of less than 0.5 MPa and is too rigid with a Young's modulus in compression greater than 5 MPa.

Preferably, the smallest dimension of the cavity (length or width) may be between 0.1 mm and 1 cm.

It should be noted that each of the layers constituting the structure is then elastically deformable so as to result in a device which is sensitive to positive pressures and/or to negative pressures.

It should be noted that the dielectric layer may or may not be porous.

Preferably, the dielectric layer comprises an electrostrictive material so as to increase the sensitivity of the local measurement of the normal mechanical stress.

For the purposes of the present invention, the term “electrostrictive material” means a material whose dielectric constant varies as a function of the deformation undergone by a layer comprising such a material.

For example, as electrostrictive materials, it is possible to cite solid foams comprising a polydimethylsiloxane polymer (commonly designated by the acronym PDMS) in which particles of carbon black or silver nanotubes are integrated at a mass concentration of between 0.1 and 20% relative to the total weight of the solid foam. Mention may also be made of the naturally electrostrictive polymers such as polyvinylidene fluoride (commonly designated by the acronym PVFD) or generally composite materials comprising conductive particles dispersed in the vicinity of a polymer matrix but below the percolation threshold.

The surface intended to be in contact with the contact element is preferably a surface having a roughness characterized by an Ra and an Rp of less than 50 μm, and preferably of between 10 μm and 50 μm. In this way, the influence of the surface intended to be in contact with the contact element is minimized on, for example, the flow of a fluid or else on the force exerted by a solid so as to obtain representative normal mechanical stress values.

It should be noted that the structure may further comprise an insulating layer applied to the dielectric layer. In other words, the insulating layer in the device may be located between the dielectric layer and the first polymeric layer. This insulating layer can make it possible to modulate the normal mechanical stress range exerted on the device and to ensure efficient use of the device when high normal mechanical stresses are exerted on the latter. In this configuration, bonding of the dielectric layer onto the first polymer layer is avoided.

According to this first aspect, the invention makes it possible to obtain a device for locally measuring a normal mechanical stress exerted by a contact element which is easy to handle and to use. The geometry of this device may be of any shape so that the latter can adapt, for example, to the geometries of conventional rheometers without being structurally modified. Also, the geometry of such a device is adaptive depending on the space in which it is desired to measure locally a normal mechanical stress exerted by a contact element. For example, this device can be used in Couette geometries and in batteries. The surface, of the device according to the invention, intended to be in contact with the contact element can therefore be small relative to the surface of the rheometer used and can be adapted to the object contact element of the measurement of normal mechanical stress such that the disturbance of this surface over, for example, the flow of a fluid or else on the force exerted by a solid, is minimized.

Also, with such a device, a single measurement is necessary to obtain the difference in normal mechanical stress in order to obtain, for example, a local rheological measurement of the normal mechanical stress exerted by a contact element.

In a particular embodiment, it is advantageous to have a device that is sufficiently sensitive to measure a greater number of low normal mechanical stresses. Consequently, in this embodiment, the dielectric layer may have a Young's modulus of between 0.5 and 5 MPa.

In a particular embodiment, it is advantageous to have an electrical connection between a measuring apparatus and the electrically conductive layer to measure in real time the variation in capacitance of the capacitor as a function of the normal mechanical stress exerted by the contact element. Consequently, in this embodiment, the device may further comprise an electrical connection connected to the electrically conductive layer, the electrical connection being intended to connect the electrically conductive layer to an element for measuring the normal mechanical stress exerted by the contact element on the second polymeric layer as a function of the variation in capacitance of the capacitor. In this way, it is also possible to activate the measurement of the capacitor when desired.

In a particular embodiment, it is advantageous to measure the normal mechanical stress exerted by the contact element over the whole of a predefined surface while guaranteeing a precise measurement. To do this, several normal mechanical stresses exerted locally on several pre-established areas included in said predefined surface can be measured when the device comprises multiple cavities. Preferably, in this embodiment,
multiple electrically conductive layers may be arranged on the substrate,
the first polymeric layer may comprise several through-cavities, each of the through-cavities being defined by a volume and extending between one of the electrically conductive layers and the dielectric layer.

Furthermore, with the presence of several capacitors coming from the aforementioned configuration, it is then possible to measure the normal forces in contact with the device and circulating at several of the capacitors then formed. For example, it is then possible to establish the behavior of the mean vertical pressure exerted by a fluid as a function of the shear rate also.

According to a second aspect, the invention relates to a system for locally measuring a normal mechanical stress exerted by a contact element, the system comprising:
a device as described above,
a rheometer comprising a lower surface intended to be arranged on the side of the substrate of the device and an upper surface intended to be arranged on the side of the second polymeric layer, and
an element for measuring the normal mechanical stress exerted by a contact element on the second polymeric layer as a function of the variation in capacitance of the capacitor or capacitors.

For example, an electronic element capable of collecting and translating electrical signals emitted by the device which are a function of the capacitance variation of the capacitor or capacitors may be used as the measuring element.

This system notably has the advantage of being sensitive over a wide range, namely between 1 and 500 Pa, and also of having a high time resolution that can extend from 0.1 KHz to reach 10 KHz when the measurement element is suitable. It should also be noted that this resolution also depends on the number of through-cavities contained in the device and the maximum number of capacitors to which the measurement element can be connected. For example, it is possible to manufacture a device capable of obtaining measurements every 4 mm², i.e. a device comprising between 10 and 100 cavities (measurement points) distributed over a surface of 4 cm².

In a particular embodiment, it is advantageous to simultaneously measure different pre-established areas of a predefined contact surface between the device and the contact element. Consequently, in this embodiment, when the device comprises several capacitors, the measuring element can be connected to each electrically conductive layer of each of the capacitors.

The invention also relates to a use of the system as described above for locally measuring a normal mechanical stress exerted by a contact element, the use comprising the following successive steps:
i. inserting the device between the lower and upper surfaces of the rheometer,
ii. applying a contact element between the upper layer of the rheometer and the surface of the second polymeric layer, intended to be in contact with the contact element, of the device,
iii. observing a variation in capacitance of the capacitor, and
iv. deducing the normal mechanical stress exerted locally by the contact element.

According to a third aspect, the invention relates to a method for manufacturing a device for locally measuring a normal mechanical stress exerted by a contact element, the method comprising the following steps:
a) forming an assembly comprising a substrate and a first polymeric layer according to the following steps:
a1) providing a substrate comprising at least one through orifice inside which an electrically conductive layer, called the lower electrode, is applied,
a2) applying onto the substrate a first polymeric layer having a thickness of between 1 μm and 500 μm and comprising at least one through-cavity, said through-cavity being applied facing the electrically conductive layer, and
b) forming a structure according to the following steps:
b1) forming a mixture comprising a polymer, a cross-linking agent, conductive fillers, a dispersant, a solvent, and optionally a surfactant,
b2) shaping said mixture to obtain a dielectric layer having a thickness of between 50 μm and 2000 μm,
b3) applying, onto the dielectric layer, a conductive mixture comprising a solvent and a conductive material,
b4) evaporating the solvent to obtain an electrically conductive monolithic layer, called the upper electrode, having a thickness of between 5 μm and 20 μm and drying,
b5) applying, onto the electrically conductive monolithic layer, a second polymeric compound to obtain a second polymeric layer,
b6) forming the second polymeric layer in order to obtain a thickness of between 10 and 500 μm and a surface intended to be in contact with the contact element, and cross-linking,
c) applying the structure to the first polymeric layer of the assembly.

It should be noted that the shaping step b2) is preferably to be performed cold. Furthermore, no cross-linking is necessary before the implementation of the shaping step b2).

In a variant embodiment, the method may further comprise, during step a), a step of creating an electrical connection connected to the electrically conductive layer and capable of connecting it to a measurement element.

Preferably, the substrate provided in step a) can comprise several through orifices inside which electrically conductive layers are arranged and the first polymeric layer arranged in step b) may comprise several through-cavities each of which is applied facing each of the electrically conductive layers.

The invention will be better understood on reading the following description, which is provided solely by way of example, and with reference to the appended figures in which:

FIG. 1 schematically depicts a cross-sectional view of a device according to a particular embodiment of the invention;

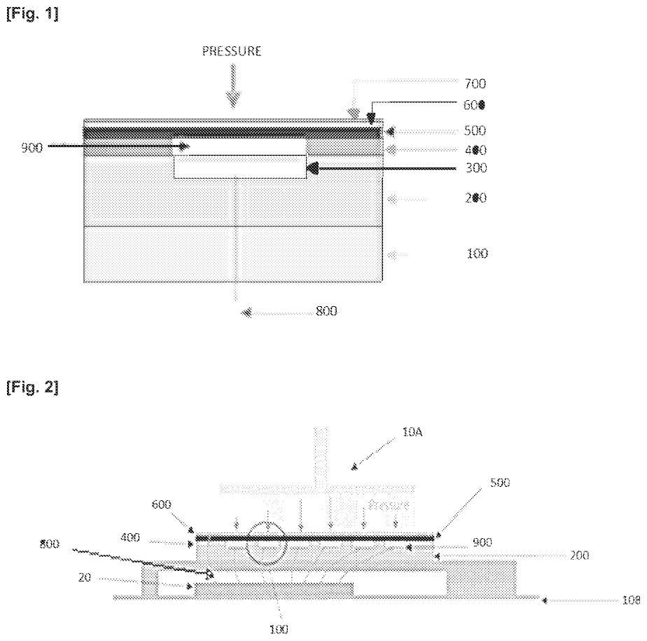

FIG. 2 schematically shows a longitudinal sectional view of a system according to a particular embodiment of the invention;

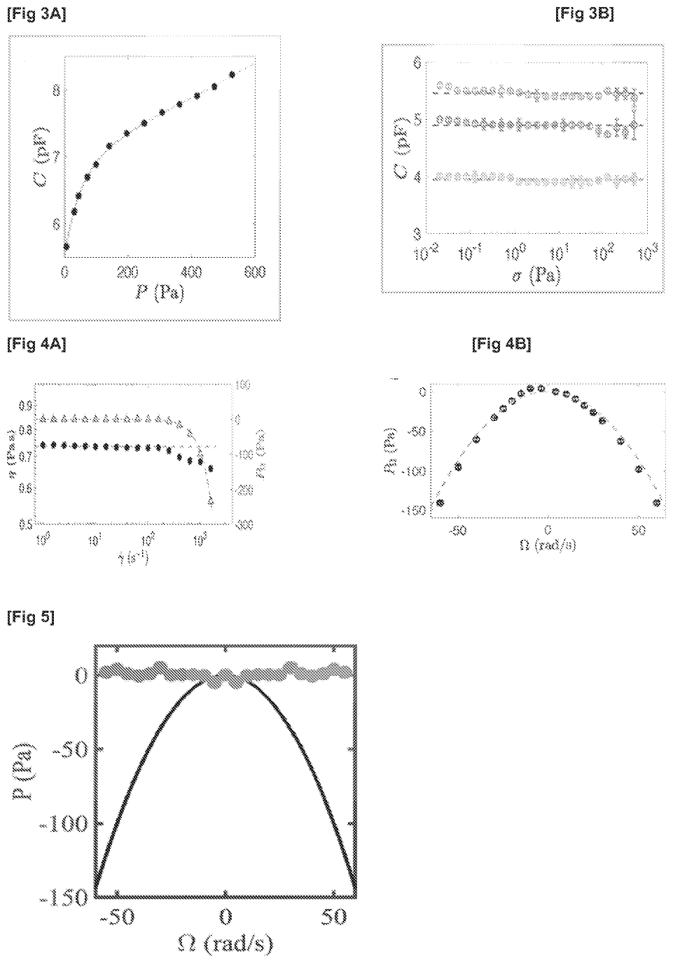

FIG. 3A shows a typical calibration curve of a device of the invention;

FIG. 3B shows the capacitance behavior of three capacitors included in a device according to the invention and which is subjected to a shear stress;

FIG. 4A illustrates the behavior measured by a device according to the invention of viscosity as a function of the average normal stress of a viscous solution;

FIG. 4B shows the behavior measured by a device according to the invention comprising an electrostrictive dielectric layer of the average normal pressure as a function of an angular velocity of a rotor; and

FIG. 5 shows the behavior measured by a device according to the invention comprising a dielectric layer which is not electrostrictive of the average normal pressure as a function of an angular speed of a rotor.

FIG. 1 shows a rheology device for locally measuring a pressure of a fluid.

In this particular embodiment of the invention, the contact element is a fluid which may, for example, be a suspension, a viscoelastic fluid such as a hydrolyzed polyacrylamide solution (commonly referred to by the acronym HPAM), or a Newtonian fluid such as glycerol or water, for example.

The device comprises a substrate 200 comprising, over at least a part of its surface, an electrically conductive layer 300, called the lower electrode. This electrically conductive layer 300 is discontinuous so as to reveal several electrically conductive layers 300 arranged on the surface of the substrate. These electrically conductive layers are similar to multiple portions arranged in a predefined manner on the surface of the substrate so as to reveal an array of lower electrodes applied to the substrate.

In this preferred embodiment, the substrate 200 is preferably made of polymer, and may in particular be a polyester film such as Mylar®, or else an epoxy resin composite reinforced with glass fiber, for example the material FR-4. However, as a variant, the substrate 200 may, for example, be made of Kapton® or else comprise a glass surface.

In this embodiment, the electrically conductive layer 300 is for its part made of copper. The electrically conductive layer 300 may be square, for example, (not illustrated in the figures) and have the following dimensions: 4 cm on the side and each of the conductive portions is square in shape with a side of 0.5 cm and the set of conductive portions being arranged in 25 squares. As a variant, the electrically conductive layer 300 may also, for example, be made of a metal layer, or a layer based on conductive organic molecules, such as a poly (3,4-ethylenedioxythiophene) layer (commonly designated by the acronym PEDOT) for example, or a layer made of a composite material comprising conductive particles such as carbon black, graphene, carbon nanotubes, silver wires, or silver platelets.

The device also comprises a first electrically insulating polymeric layer 400 having

a thickness of between 1 μm and 500 μm and comprising several, six for example, through-cavities 900 (in FIG. 1, a single cavity is shown, whereas in FIG. 2, the six through-cavities 900 are shown), the first polymeric layer 400 being arranged on the substrate 200 and is preferably of the same shape as the latter so as to conform entirely to its surface. The first polymeric layer 400 therefore comprises several through-cavities 900, each of the through-cavities 900 being defined by a volume and extending between one of the electrically conductive layers 300 and a dielectric layer 500. Each of these through-cavities 900 may be of any shape and have dimensions of between 1 and 500 μm (micrometers) or else between 0.5 mm and 10 mm. For example, in this preferred embodiment, each of these through-cavities 900 is square in shape and has sides approximately equal to 12 μm.

This polymeric layer 400 is similar to a polymeric mesh thus separating the measuring surface from the lower electrodes.

In this embodiment, the first polymeric layer 400 is made of (poly (ethylene terephthalate)) (commonly designated by the acronym PET), and is in particular Mylar® based. However, as a variant, the first polymeric layer 400 may, for example, be made of polydimethylsiloxane (commonly designated by the acronym PDMS), of polytetrafluoroethylene based on Teflon® for example, or else of polyimide based on Kapton® for example.

The device further comprises a structure arranged on the first polymeric layer 400. In particular, this structure may be in the form of a three-dimensional object, one of the dimensions thereof being significantly lower than the other two. For example, this structure can have in a parallelepipedal form defined by a thickness of between 65 μm and 2520 μm, and by a length and a width similar to those of the first polymeric layer 400. In particular, in this embodiment, the structure has a thickness approximately equal to 600 μm. The structure is also designed to be elastically deformable along its width and its length.

In particular, the structure comprises the following successive layers:
the dielectric layer 500 having a thickness approximately equal to 500 μm, and arranged on the first polymeric layer 400,
an electrically conductive monolithic layer 600, called the upper electrode, the monolithic layer 600 having a thickness approximately equal to 25 μm, and
a second polymeric layer 700 comprising a surface intended to be in contact with the fluid, the second polymeric layer 700 having a thickness approximately equal to 50 μm.

In another example, the structure may have a thickness approximately equal to 500 μm and comprise the following successive layers:
the dielectric layer 500 having a thickness approximately equal to 5 μm, and arranged on the first polymeric layer 400,
an electrically conductive monolithic layer 600, called the upper electrode, the monolithic layer 600 having a thickness approximately equal to 200 μm, and
a second polymeric layer 700 comprising a surface intended to be in contact with the fluid, the second polymeric layer 700 having a thickness approximately equal to 300 μm.

In this preferred embodiment, the dielectric layer 500 is made of an electrostrictive material, in particular one of those disclosed in the international patent application WO2019129388, in particular in paragraphs to of said application as published. For example, the dielectric layer 500 may be made of a composite material comprising conductive fillers of carbon black and PDMS, this material having a dielectric permittivity of between 2 and 1000 @ 100 Hz (or at least greater than that of the air 1) and having a Young's modulus approximately equal to 2 MPa. However, this dielectric layer may be all dielectric layers known to a person skilled in the art and configured to be elastically deformable and to be able to transmit an electrical signal so as to allow the measurement of the capacitance variation of the capacitors.

In this embodiment, the monolithic layer 600 is made of a composite material comprising PDMS and silver fillers. However, alternatively, monolithic layer 600 may, for example, comprise PDMS as well as fillers such as silver nanowires, nanotubes, graphene for example, or conductive organic molecules such as PEDOT, or may also be a PDMS layer onto which is deposited a gold or silver based conductive metal layer for example. The monolithic layer 600 may also be made of PDMS with carbon black, PDMS foam with carbon black, or polymer foam with electric current conductive fillers.

In this embodiment, the second polymeric layer 700 is made of PDMS and has a Young's modulus close to that of the dielectric layer 500, namely approximately equal to 2 MPa. However, as a variant, the second polymeric layer 700 may, for example, be made of silicone.

It should also be noted that the surface intended to be in contact with the fluid of the second polymeric layer 700 can be striated or else micropatterned while nevertheless having a residual roughness and flatness defects which are preferably not greater than values of the order of 10 to 50 μm.

Thus, each of the through-cavities 900 is defined by a volume. Each of said volumes may be equal or different depending on the desired sensitivities and the predefined geometries. Also, each of the through-cavities 900 therefore extends between the electrically conductive layer 300 and the dielectric layer 500.

There is therefore an assembly comprising the through-cavities 900, the dielectric layer 500 and the lower 300 and upper 600 electrodes which form as many capacitors as through-cavities 900. It should be noted that at least one of these through-cavities 900 can be at atmospheric pressure or under slight compression when the structure is compressed.

The elastically deformable structure is therefore adapted so that when a normal mechanical stress is exerted on the surface of the second polymeric layer 700 intended to be in contact with the contact element, the volume of the through-cavity 900 varies so as to modify the capacitance of the capacitor.

The device of this embodiment further comprises an electrical connection 800 connected to the electrically conductive layer 300. In particular, this electrical connection 800 is intended to connect the electrically conductive layer 300 to an element 20 for measuring the normal mechanical stress exerted by the contact element on the second polymeric layer 700 according to the variation in capacitance of the capacitor.

This device can be manufactured as follows.

First of all, a step a) of forming an assembly comprising the substrate and the first polymeric layer indicated above is carried out.

To do this, a sub-step a1) of supplying the substrate 200 is implemented, then a sub-step a2) of application onto the substrate 200 of the first polymer layer 400 so that each of the through-cavities 900 is located facing each of the portions of the electrically conductive layers 300.

For example, to do this, a first polymeric layer 400 of PDMS with a thickness of approximately 5 μm is applied to a Mylar® substrate 200. This first polymeric layer 400 of PDMS comprises through-cavities 900 and has been deposited beforehand using a spin-coater and hardened for 1 h at 70° C.

Also, step a) of forming the assembly further comprises a step of creating the electrical connection 800 connected to each of the electrically conductive layers 300 and capable of connecting them to a single measurement element 20 which is preferably an acquisition card. In this way, it is possible to consider the measurement only of certain capacitors.

Next, a step b) of forming the structure as described previously is carried out according to the following steps.

To do this, a sub-step b1) is implemented for forming a mixture comprising a polymer, a cross-linking agent, conductive fillers, optionally a dispersant, a solvent, and optionally a surfactant. In this preferred embodiment, the mixture is one of those disclosed in international patent application WO2019129388, in particular in paragraphs [0099] to [00164] of this application as published. In particular, a mixture consisting of droplets of an aqueous dispersion of carbon black fillers suspended in a PDMS matrix and a curing agent is produced.

For example, an oily phase is prepared by mixing PDMS (for example that sold under the name RTV615 Momentive), a curing agent (for example that sold under the name RTV615 Momentive) so as to have a curing agent concentration equal to 10% by weight relative to the PDMS phase, and lauryl PEG-8 dimethicone (for example that sold under the name Silube J208-812, Siltech) so as to have a concentration of lauryl PEG-8 dimethicone approximately equal to 5.0% by weight relative to the oily phase.

An aqueous phase is, for its part, prepared by mixing 5 g of gum arabic (for example that sold by the company Sigma Aldrich), 95 g of deionized water, and carbon black fillers (for example the carbon black powder sold by Alfa Aesar). This mixture is sonicated at a point for 1 h at 400 W to disperse the carbon black fillers homogeneously and obtain the aqueous phase.

The mixture is then prepared by gradually adding the aqueous phase to the oily phase with manual stirring up to a water:oil mass ratio of 80% by weight.

In another example, the monomers, cross-linker, and surfactant are first mixed. For example, particles of carbon blacks in a monomer phase are dispersed in the presence of a surfactant. To do this, a dispersion of conductive fillers in water and surfactant is prepared. This dispersion is added drop-by-drop to the mixture of monomers with stirring (shear gradient from 1 to 100 s-1) to form an emulsion. The proportion of organic phase (surfactant monomer) is between 40 and 95% by volume.

The emulsion thus obtained is spread on a polymer film using a doctor blade. It is

immersed in water and brought to 80° C. to ensure cross-linking for 1 H. The assembly is then oven dried at 40° C. for 10 h.

Next, a sub-step b2) of shaping this mixture is carried out in order to obtain the dielectric layer 500 described above. For example, the mixture, which may be in the form of a paste, is spread using a stencil with a depth of 1.2 mm, or by means of a Zehntner ZUA 2000 applicator, on a plastic surface 24 mm in diameter so as to obtain a layer having a thickness approximately equal to 1 μm.

According to a first embodiment of the dielectric layer 500, a second plastic surface is placed onto the spread mixture such that the mixture remains confined between two flat surfaces. The solid materials are obtained by curing the PDMS polymer without evaporating in a hot water bowl (90° C.) for 4 h. The relative humidity under these conditions is 100%. Next, the layer of solid material is removed from the two plastic surfaces and dried in an oven for 1 h at 150° C. Since PDMS is permeable to water vapor, droplets of carbon black filler are dried and leave a structure with pores of a spherical shape covered with carbon black fillers. Thus, when a pressure is applied to this layer, the pores, which are in particular micropores (with a size of between 1 and 10 μm), deform, which induces a high variation in the permittivity and therefore the capacitance of said layer.

According to a second embodiment of the dielectric layer 500, after the spreading, the paste is cured according to a two-step process. First of all, it is placed in a 70° C. deionized water bath for 6 hours to ensure the cross-linking of the PDMS polymer. After curing, the solid is left to dry at 70°° C. for 24 h so that all the water contained in the pores evaporates. After curing and drying, the mixture is transformed into a piezocapacitive soft solid foam. Its relative flexibility (with a Young's modulus of 1.6 MPa) is at the origin of its remarkable piezocapacitive properties.

However, other mixtures and methods known to a person skilled in the art may be used herein to produce the dielectric layer 500, for example, see the teaching of the reference [2].

Next, a sub-step b3) of applying a conductive mixture, which may be in the form of a paste, comprising a solvent, PDMS, and a conductive material, in particular silver particles, is carried out on the dielectric layer 500. In particular, the upper part of the dielectric layer is covered (for example using the Zehntner ZUA 2000 applicator) with the conductive mixture so as to obtain a thick 25 μm layer which plays the role of a flexible electrode.

A sub-step b4) of evaporating the solvent is then carried out in order to obtain the electrically conductive monolithic layer 600 described above, called the upper electrode. Then drying is carried out.

It is now possible to produce a sub-step b5) of applying a second polymeric compound onto the electrically conductive monolithic layer 600, in order to obtain the second polymeric layer 700. To do this, a protective layer of PDMS is poured around the monolithic layer 600. Polymeric layer 700 may for example follow the same procedure as the production of dielectric layer 500, but no conductive fillers are added.

Then, a sub-step b6) of shaping the second polymeric layer 700 is carried out in order to obtain the desired thickness and having the surface intended to be in contact with the fluid as described above. A cross-linking of the PDMS is also carried out, for example by using heat, illumination under UV rays or any other means known to a person skilled in the art. In particular, the PDMS, which is initially liquid, is left to rest for 30 minutes at ambient temperature to ensure that the measurement surface (surface intended to be in contact with the fluid) is flat. It is then cured for 1 h at a temperature approximately equal to 70° C.

Finally, a step c) of applying the structure to the first polymeric layer of the assembly is implemented.

Thus, the device is obtained according to the particular embodiment described above. In particular, the device comprises several capacitors consisting of each of the through-cavities 900 of the device as well as lower and upper electrodes.

Once the device is manufactured, it is possible, for example, to use it in a system for locally measuring a pressure of a fluid (see FIG. 2).

The system comprises the device described above, a rheometer comprising a lower surface 10B intended to be arranged on the side of the substrate of the device and an upper surface 10A intended to be positioned on the side of the second polymeric layer 700, as well as an element 20 for measuring the pressure exerted by the fluid on the second polymeric layer 700 as a function of the variation of each of the capacitances of the capacitors.

The rheometer is a conventional rheometer known to a person skilled in the art.

The measuring element 20 here is an acquisition card capable of defining a pressure value from a variation in capacitance. The acquisition card is connected to each electrically conductive layer 300 of each of the capacitors.

It should be noted in particular that this system can be used as follows.

A step i. is carried out, inserting the device between the lower 10B and upper 10A surfaces of the rheometer.

Then, a step ii. is carried out to apply the fluid to be analyzed between the upper layer 10A of the rheometer and the surface of the second polymeric layer 700, intended to be in contact with the fluid, of the device.

Then, in a step iii. observing a variation in capacitance of the capacitors, how the fluid exerts a pressure force on the second polymer layer is controlled by collecting, by means of the acquisition card, which can be located below a measuring surface 100 on which the device is arranged, the values of variations in capacitance of each of the capacitors of the device.

The acquisition card is preferably suitable for measuring the capacitances of each capacitor generated at a frequency of 1000 Hz. This high resolution makes it possible to finely measure the local pressure profiles, i.e. the pressures exerted on each of the through-cavities 900 as a function of time.

Finally, in a step iv. of deducing the pressure of the fluid exerted locally, the values

of variations in capacitance of each of the capacitors are translated by means of electrical data processing means into values representative of the pressure actually exerted by the fluid on the second polymer layer of the device 700. The electrical data can be directly acquired via a USB port and exported directly via data processing software such as Matlab®.

Indeed, when the fluid to be analyzed is in contact with the surface intended to be in contact with the fluid of the device, the through-cavities 900 are deformed, and by extension also their initial volume, in response to the local pressures exerted on the second polymeric layer 700 when a fluid is sheared between the upper surface of a rheometer and the surface intended to be in contact with the fluid. Consequently, each through-cavity 900 sees its capacitance value be modified. These capacitance values are measured over time and space in particular using the acquisition card and make it possible to go back to the pressure profile after, in particular, a capacitance/pressure calibration of each of the through-cavities 900.

Example of use according to a device of the invention comprising the dielectric layer 500 according to the second embodiment of the above-mentioned dielectric layer 500.

FIG. 3A shows a typical calibration curve of a device of the invention, in particular of a device comprising the dielectric layer 500 according to the second embodiment of the above-mentioned dielectric layer 500 for pressures P applied by a liquid on the surface intended to be in contact with a liquid of the device. This calibration curve shows the capacitance C according to the hydrostatic pressure exerted by the liquid.

Three devices according to the second embodiment of the aforementioned dielectric layer 500 may also be used simultaneously. In this example, one of these devices is positioned at the center of a geometry of a rotary rheometer (i.e. the plane-pin) (at a distance r=0) and the other two are placed diagonally at a distance r=12 mm from the center. It is then possible to note in FIG. 3B the behavior of the capacitance of these three devices when each of them is subjected to a variable shear stress o exerted by a fluid.

FIG. 4A for its part has a negative pressure profile in a Newtonian fluid at the time of the appearance of convective rollers. In particular, using the graph of FIG. 4A, it is possible to read a viscosity q as a function of an average normal stress of a solution exerted on the device of the invention comprising the dielectric layer 500 according to the second embodiment of the dielectric layer 500 mentioned above, the solution comprising water and glycerol at a volume concentration approximately equal to 98% relative to the total volume of the solution as a function of the temperature applied to the device.

Using FIG. 4B, the profile of the average normal pressure measured by the device of the invention, comprising the dielectric layer 500 according to the second embodiment example of the above-mentioned dielectric layer 500, is observed as a function of the angular velocity Ω. of the upper plane of the rheometer, in other words the rotor which faces a stator. The curves are the parabolic adjustments expected by the theory.

Each of the curves of FIGS. 4A and 4B is the parabolic adjustment expected from the theory. By way of comparison, FIG. 5 shows the profile of the average normal pressure measured by the device of the invention comprising a dielectric layer free of carbon fillers, as a function of the angular velocity Ω. of the upper plane of the rheometer. It is to be noted that the profile obtained (horizontal curve) does not coincide with the theoretical profile (concave curve). Thus, to have optimized results, it is preferable to have a dielectric layer comprising carbon fillers.

It should be noted that the invention may be applied to fields other than those of rheology. For example, the invention can be integrated with sensors suitable for integrating into batteries.

### LIST OF REFERENCES

[1] De Cagny, H., Fazilati, M., Habibi, M., Denn, M. M., & Bonn, D. (2019). The yield normal stress. Journal of Rheology, 63(2), 285-290.
[2] Publication de Mickaël Pruvost, Wilbert J. Smit, Cécile Monteux, Philippe Poulin, Annie Colin in Nature journal (2019). Polymeric foams for flexible and highly sensitive low-pressure capacitive sensors.

1. Device for locally measuring a normal mechanical stress exerted by a contact element, said device comprising:
a substrate comprising, over at least a part of its surface, at least one electrically conductive layer, called the lower electrode,
a first electrically insulating polymeric layer having a thickness comprised between 1 μm and 500 μm and comprising at least one through-cavity, the first polymeric layer being arranged on the substrate,
a structure arranged on the first polymeric layer, the structure comprising the following successive layers:
a dielectric layer having a thickness of between 50 μm and 2000 μm and arranged on the first polymeric layer,
an electrically conductive monolithic layer, referred to as the upper electrode, the monolithic layer having a thickness of between 5 μm and 50 μm, and
a second polymeric layer comprising a surface intended to be in contact with the contact element, the second polymeric layer having a thickness of between 10 and 500 μm,
the through-cavity being defined by a volume and extending between the electrically conductive layer and the dielectric layer, the assembly comprising the through-cavity, the dielectric layer and the lower and upper electrodes forming a capacitor,
the structure being elastically deformable such that when a normal mechanical stress is exerted on the surface of the second polymeric layer intended to be in contact with the contact element the volume of the through-cavity varies so as to change the capacitance of the capacitor.

2. The device according to claim 1, wherein said dielectric layer has a Young's modulus of between 0.5 and 5 MPa.

3. The device according to claim 1, further comprising an electrical connection connected to said electrically conductive layer, said electrical connection being intended to connect said electrically conductive layer to an element for measuring the normal mechanical stress exerted by the contact element on the second polymeric layer as a function of the variation in capacitance of the capacitor.

4. The device according to claim 1, wherein:
multiple electrically conductive layers are arranged on the substrate,
the first polymeric layer comprises several through-cavities, each of the through-cavities being defined by a volume and extending between one of said electrically conductive layers and the dielectric layer.

5. A system for locally measuring a normal mechanical stress exerted by a contact element, said system comprising:
a device according to one of claim 1,
a rheometer comprising a lower surface intended to be arranged on the side of the substrate of the device and an upper surface intended to be arranged on the side of the second polymeric layer, and
an element for measuring the normal mechanical stress exerted by a contact element on the second polymeric layer as a function of the variation in capacitance of the capacitor or capacitors.

6. System according to claim 5, wherein, when said device comprises multiple capacitors, said measurement element is connected to each electrically conductive layer of each of said capacitors.

7. Use of the system according to claim 5 for locally measuring a normal mechanical stress exerted by a contact element, the use comprising the following successive steps:
i. inserting the device between the lower and upper surfaces of the rheometer,
ii. applying a contact element between the upper layer of the rheometer and the surface of the second polymeric layer, intended to be in contact with the contact element, of the device,
iii. observing a variation in capacitance of the capacitor, and
iv. deducing the normal mechanical stress exerted locally by the contact element.

8. Method for manufacturing a device for locally measuring a normal mechanical stress exerted by a contact element, said method comprising the following steps:
a) forming an assembly comprising a substrate and a first polymeric layer according to the following steps:
a1) providing a substrate comprising at least one through orifice inside which an electrically conductive layer, called the lower electrode, is applied,
a2) applying onto said substrate a first polymeric layer having a thickness of between 1 μm and 500 μm and comprising at least one through-cavity, said through-cavity being applied facing the electrically conductive layer, and
b) forming a structure according to the following steps:
b1) forming a mixture comprising a polymer, a cross-linking agent, conductive fillers, a dispersant, a solvent, and optionally a surfactant,
b2) shaping said mixture to obtain a dielectric layer having a thickness of between 50 μm and 2000 μm,
b3) applying, onto the dielectric layer, a conductive mixture comprising a solvent and a conductive material,
b4) evaporating the solvent to obtain an electrically conductive monolithic layer, called the upper electrode, having a thickness of between 5 μm and 20 μm and drying,
b5) applying, onto said electrically conductive monolithic layer, a second polymeric compound to obtain a second polymeric layer,
b6) forming said second polymeric layer in order to obtain a thickness of between 10 and 500 μm and a surface intended to be in contact with the contact element, and cross-linking,
c) applying said structure to said first polymeric layer of said assembly.

9. The method according to claim 8, further comprising, during step a), a step of creating an electrical connection connected to the electrically conductive layer and capable of connecting it to a measurement element.

10. The method according to one of claim 8, wherein the substrate provided in step a) comprises several through-orifices inside which are arranged electrically conductive layers and said first polymeric layer arranged in step b) comprises several through-cavities each of which is applied facing each of said electrically conductive layers.
